(19) United States
(12) Patent Application Publication
(10) Pub. No.: US 2026/0121957 A1
(43) Pub. Date: Apr. 30, 2026

(54) PRECISE FAST LOSS DETECTION

(71) Applicant: MICROSOFT TECHNOLOGY LICENSING, LLC, Redmond, WA (US)

(72) Inventors: Torsten HOEFLER, Pfaeffikon (CH); Abdul KABBANI, Redmond, WA (US)

(21) Appl. No.: 19/003,995

(22) Filed: Dec. 27, 2024

Related U.S. Application Data
(60) Provisional application No. 63/687,303, filed on Aug. 26, 2024.

(51) Int. Cl. H04L 43/0829; H04L 43/12; H04L 47/125

(52) U.S. Cl. CPC H04L 43/0835; H04L 43/12; H04L 47/125

(57) ABSTRACT

In a computing network implementing an adaptive load balancing scheme using entropy values (EVs) to select network paths, the next expected packet sequence numbers (PSNs) sent along different paths are tracked. A generation number is increased to obtain a new EV and a last probe packet is sent to clear an old EV. If a starting PSN is divisible by a number k, an entropy slot is derived for each PSN using a modulo function based on k.

### CROSS-REFERENCE TO RELATED APPLICATION

This application claims the benefit of U.S. provisional application No. 63/687,303 filed on Aug. 26, 2024, entitled “Precise Fast Loss Detection” the entirety of which is hereby incorporated by reference herein.

### BACKGROUND

As more data and services are stored and provided online via network connections, providing high performance and an optimal and reliable user experience is an important consideration for network providers and computer networking device manufacturers. In various examples, computer networking devices can include electronic devices that communicate and interact over a computer network via network packets such as gateways, routers, and switches. A network packet can be a formatted unit of data containing control information and user data. Such computer networking devices can implement software programs that process and execute network operations such as packet routing, rewriting, filtering and so forth.

Networking is becoming increasingly important for a number of use cases. For example, AI models such as Large Language Models (LLMs) are trained on clusters of thousands of GPUs, and network latency is critical for system performance. High-performance computing (HPC) is another use case that requires demanding network performance in terms of bandwidth and latency.

It is with respect to these and other considerations that the disclosure made herein is presented.

### SUMMARY

The techniques described herein enhance the performance of computer networks by implementing the methods described herein. The techniques of the present disclosure enable several technical benefits over existing approaches, in particular for enabling architectures that optimize network protocols such as Ethernet for high performance applications such as artificial intelligence AI and high-performance computing (HPC). Technical benefits include improved bandwidth, scale, and lower latency.

Loss can be readily detected at a destination if in-order delivery is used. The loss is detected by gaps in the packet sequence numbers (PSNs) (typically 32 bits). However, in packet sprayed networks, packets can arrive out of order along different paths to the destination, which can make loss detection difficult.

The disclosed embodiments address the above problem by extending existing load balancing schemes (bitmap/resource partitioning Recycled Entropy Packet Spraying (REPS)) to support fast and precise loss detection.

The disclosed embodiments include multiple schemes that use different entropy values (EVs) to select different paths through Equal-Cost Multi-Path (ECMP), using the observation that all packets sent with the same EV are received in the order they were sent. Initially, it is assumed that ACKs with the same EV are in order and ACKs carry the same EV as the forward packets, and the mechanism can be implemented at the sender. This can be extended by carrying the necessary information (e.g., next PSN) in each packet to the destination.

The disclosed embodiments keep track of different next expected PSNs sent along the different EVs/paths, initially assuming that the EVs do not change. If EVs change during operation, when changing an EV in a slot, the generation number is increased to obtain a new EV and a last probe packet is sent to clear the old EV. If the system starts at a PSN that is divisible by k, the entropy slot s for each PSN can be derived using s=PSN mod k, and is included in each packet.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the description detailed herein, references are made to the accompanying drawings that form a part hereof, and that show, by way of illustration, specific embodiments or examples. The drawings herein are not drawn to scale. Like numerals represent like elements throughout the several figures.

FIG. 1A through 1I are diagrams illustrating example architectures in accordance with the present disclosure;

FIG. 2 is a flowchart depicting an example procedure in accordance with the present disclosure;

FIG. 3 is a diagram illustrating an example architecture in accordance with the present disclosure;

FIG. 4 is a diagram illustrating an example architecture in accordance with the present disclosure;

FIG. 5 is a diagram illustrating an example architecture in accordance with the present disclosure;

FIG. 6 is an example computing system in accordance with the present disclosure.

FIG. 7 is an example computing system in accordance with the present disclosure.

### DETAILED DESCRIPTION

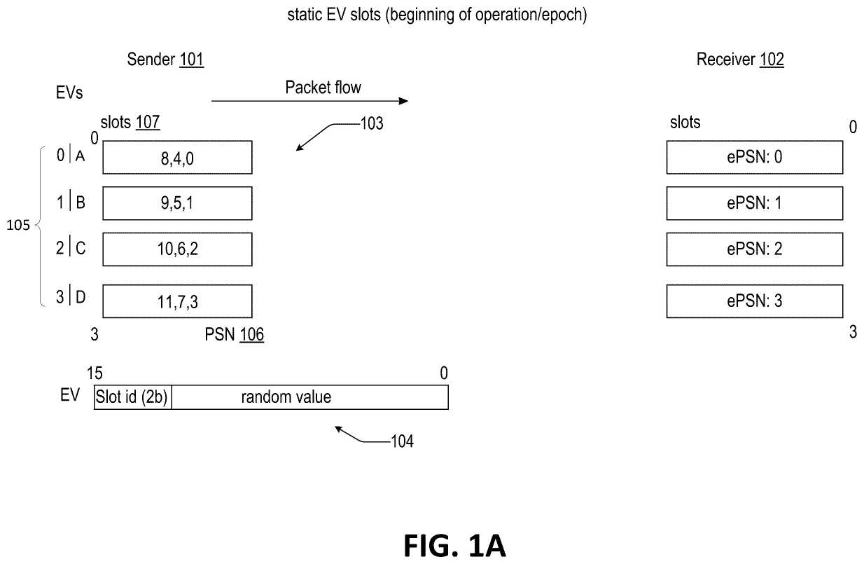

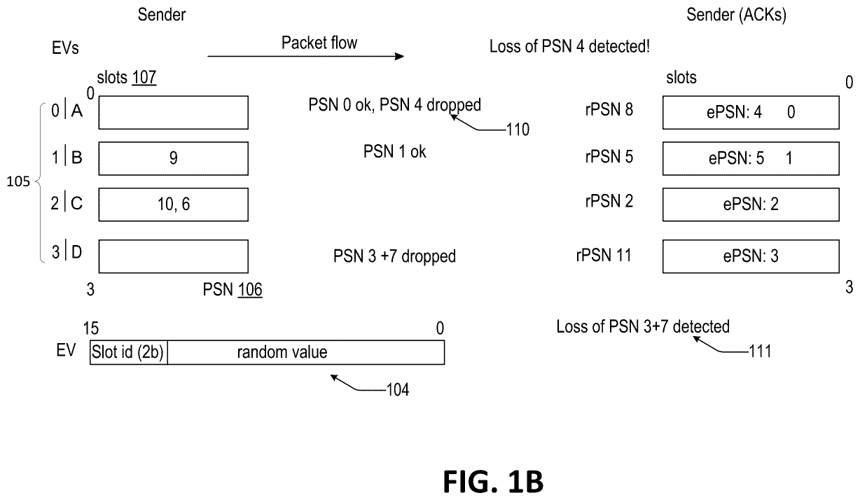

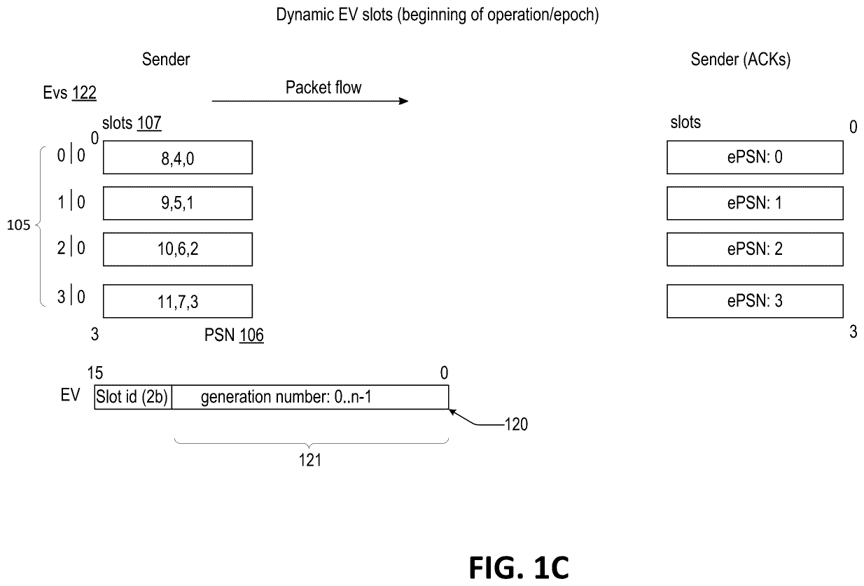

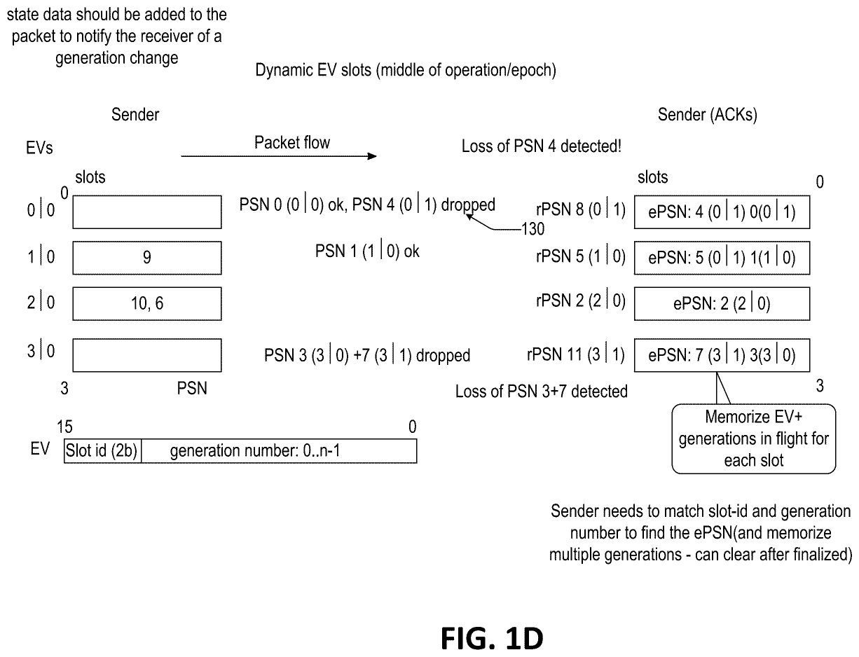

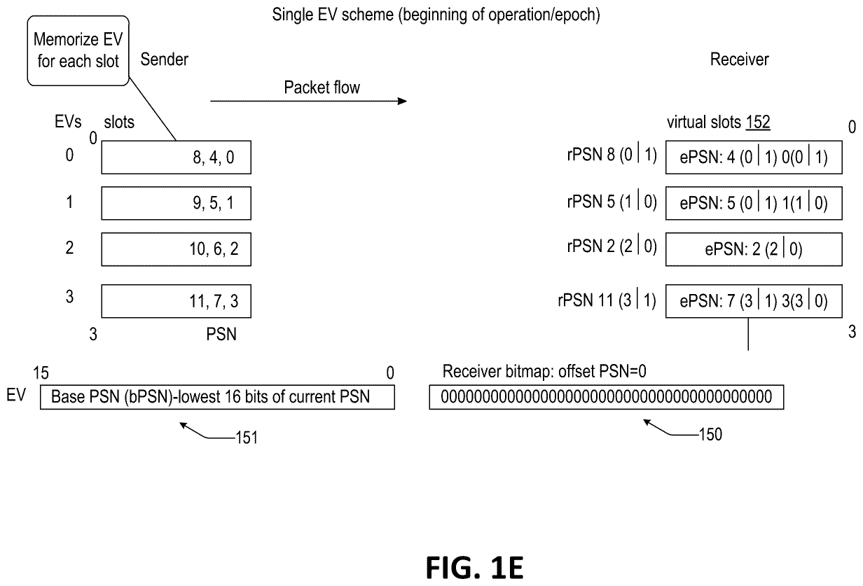

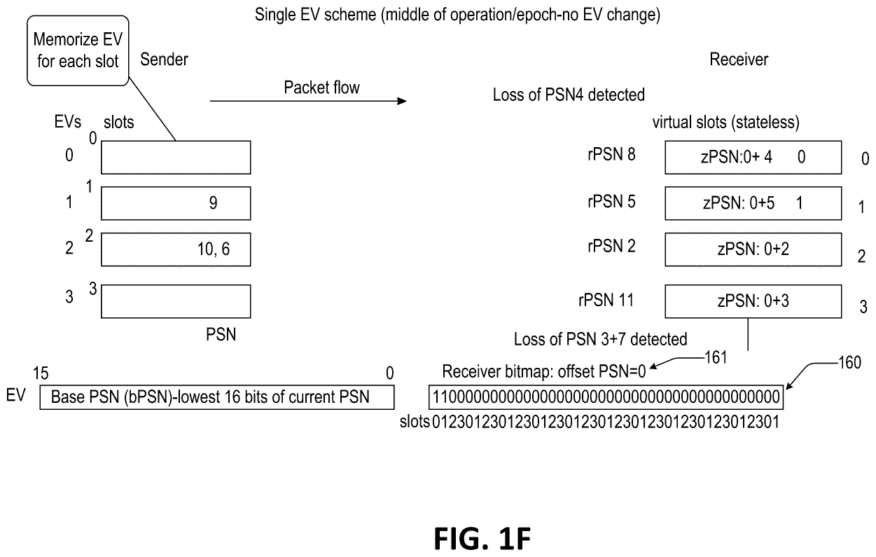

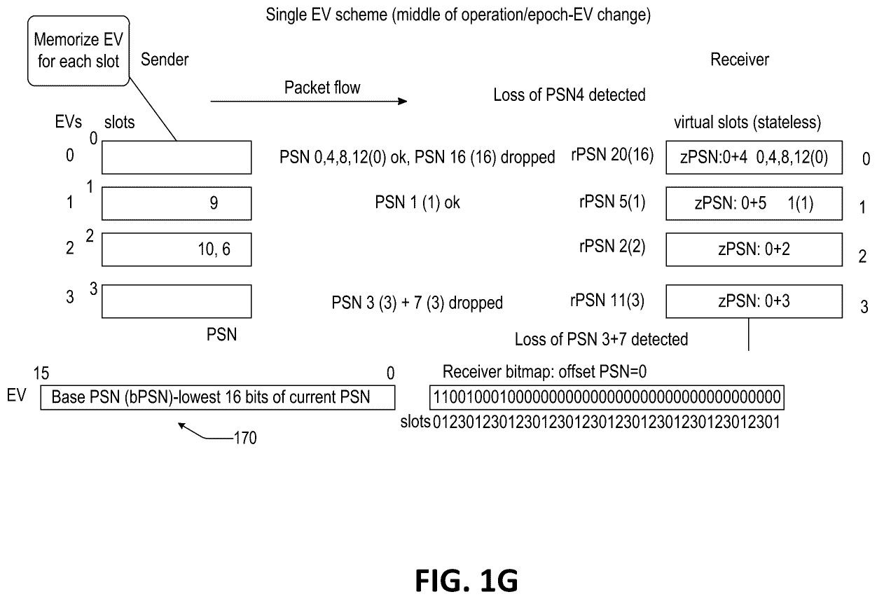

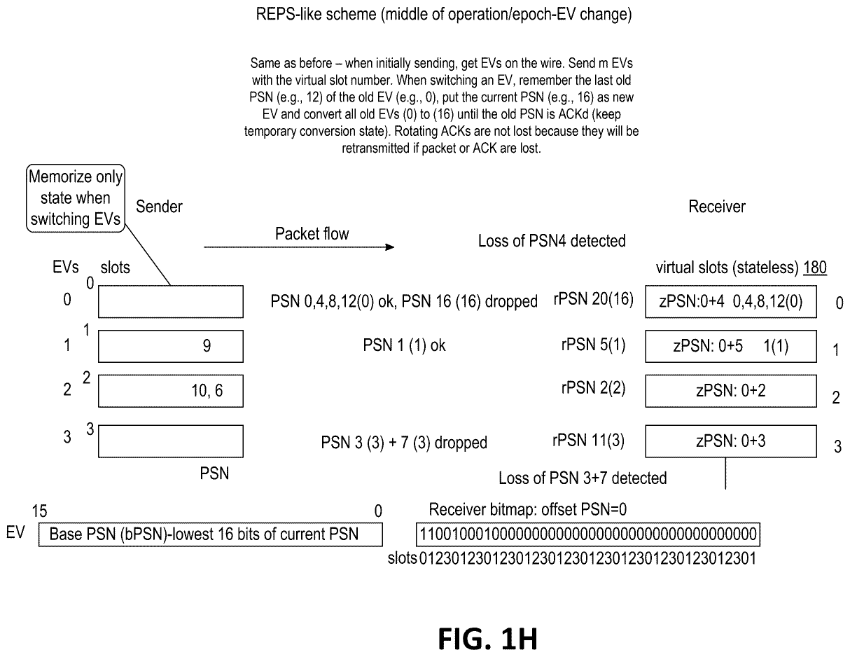

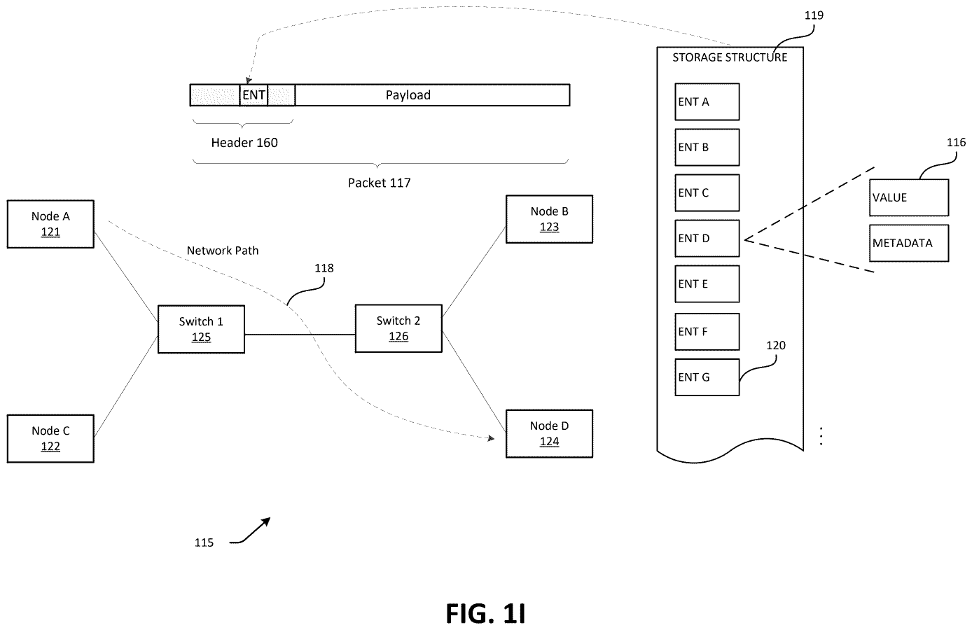

The techniques discussed herein enhance the functionality of computer networking. Various examples, scenarios, and aspects that enable enhanced networking techniques are described below with respect to FIGS. 1-7.

As used herein, entropy refers to a value or signal that can be used to select or change a network path. For example, when using ECMP, the entropy is used to change the ECMP hash, which determines the route through the switch. A change of any value in the header will cause the ECMP hash function to select another random path. Entropy in this context is therefore any bit(s), value, or signals that corresponds to a network route and is usable to select or change a network path as indicated to a device on the network, where packets with the same entropy take the same path, and packets with different entropies may take different paths (and may also randomly hash to the same path again). The term entropy may also be referred to as a routing selector or routing value.

In an embodiment, initially (e.g., before any acknowledgements (ACKs) are received), a different entropy is generated for each transmitted packet. In an embodiment, the entropy can be generated randomly or using round-robin across a list or range of entropies. In an example, the new entropy value can be the next one in the list or deterministically changed or incremented.

In an embodiment, as ACKs are received: entropies that are acknowledged not to be congested (i.e., good entropies) are saved into a data structure such as a circular FIFO. It should be appreciated that other data structures can be implemented.

In response to transmitting additional data packets, a saved entropy is reused and invalidated (or otherwise prevented from being reused). If there are no valid entropies to reuse, a different entropy is used, using various methods described herein including the use of efficient mechanisms such as a counter. By implementing such a mechanism, it is possible to avoid reusing entropies that experienced congestion while recycling entropies that did not experience or otherwise run into congestion.

When there are no more transmissions for a connection, the good entropies observed per the last batch of ACKs will be buffered as described above. If the connection is flagged as “recurrent” (i.e., the good entropies will be relevant again for the same connection at a later time when the connection resumes transmission along the same set of the other recurrent connections), it would be beneficial to save these good entropies, for example offline. Otherwise, these buffered entropies will eventually expire.

As disclosed herein, existing load balancing schemes (bitmap/REPS) are extended to support fast loss detection.

Loss can be detected at the destination if in-order delivery is used. The loss is detected by “holes” in the 32-bit packet sequence numbers (PSNs), e.g., if packets arrived with PSNs 4, 5, 6, 8, the destination knows that packet 7 was lost. In this case, the target could send a negative acknowledgment (NACK) to request retransmission of packet 7. In packet sprayed networks, packets can arrive out of order along different paths to the destination, which makes loss detection more complex. The present disclosure includes algorithmic solutions and corresponding implementations in hardware or software to detect losses.

Any loss detection scheme may produce false positives (indicating that a packet was lost that was not actually lost) or false negatives (not detecting a lost packet as lost). A false positive can lead to a “spurious retransmission” such that duplicate packets arriving at the destination waste network resources. A false negative will lead to a retransmission timeout (RTO) that reduces the network utilization and delays message transmissions.

The present disclosure includes schemes to extend ECMP-based packet spraying for precise loss detection. Different schemes provide different tradeoffs between network interface card (NIC) resource (memory) consumption and the false negative rate. Other known schemes often suffer from both false positives and negatives. All schemes use different entropy values (EVs) to select different paths through ECMP.

An EV is typically a 16-bit number encoded into the packet header (e.g., UDP source port). The EV is then used by the switches to select a specific path such that (without failures) each EV specifies exactly one path from a source NIC to a destination NIC. One observation is that all packets sent with the same EV are received in the order they were sent.

If ACKs are also received in order of the sent packets, then the loss detection mechanism can be solely implemented at the source. If ACKs are not received in order, the mechanism can be implemented at the destination, which would then send NACKs to request packet retransmission. NACKs can be handled at the source exactly like NACks for trimmed packets. Here, it is assumed that ACKs with the same EV are in order and ACKs carry the same EV as the forward packets. The schemes are described herein, some at the sender, some at the receiver. Each scheme can be switched from sender to receiver or vice versa by carrying the necessary information (e.g., next PSN) in each packet or ACK or storing some additional information locally.

In an embodiment, the disclosed scheme keeps track of different next expected PSNs sent along the different EVs/paths and it is first assumed that the EVs do not change. For example, assume four active EVs: A, D, C, D and the sender sends 12 packets round robin across the EVs, starting with PSN 0: A: 0, 4, 8; B: 1, 5, 9; C: 2, 6, 10; D: 3, 7, 11. In the simplest case, after sending a packet, its PSN is stored as “expected PSN” for a specific EV in a FIFO queue. If an ACK with the corresponding EV comes in that has a different PSN as the expected PSN (ePSN), it is determined that at least one packet was lost. This scheme detects any packet drop except for the last packet per EV. To also handle the last packets precisely, it is possible to send probe packets along each EV until the first probe is ACK′d at the sender when the queue is empty to also detect loss of the last packet. However, local FIFO requires storage of all ePSNs of all packets in flight and thus causes large memory overheads.

In an embodiment, an optimization is disclosed where if the number of different entropy slots is a constant k and packets are going strictly in round robin, the sender can compute the expected packets analytically as ePSN+(i*k) for the i^{th} packet. In this way, the sender can discover that two packets have been lost in the case above. If pPSN is the previously received PSN, then the sender can store ePSN=pPSN+4 and check if the next received PSN (rPSN) matches ePSN. If the next received PSN (rPSN) does not match ePSN, then the sender can compute the missing PSNs locally.

A receiver could implement a similar algorithm. One scheme to determine the slot at either sender or receiver is to encode the slot with log k bits into the EV itself because the actual EV value does not matter if the hash function mixes well. It is also possible to compress the required storage at the endpoint by only storing the least significant bits of the PSN in order to cover all packets in flight. This scheme still requires storing one (or parts of) ePSN for each active EV, which could be problematic for large k. Assuming an 800 Gb/s link and a 10 us latency, the BDP is 1 MB. With a minimum packet size of 128 Bytes, there are <8,000 packets in flight and 13 bits are needed to encode those packets. Thus, this scheme requires k*13b of storage.

Assuming that EVs change during operation (which is usually the case), the scheme can be modified as follows: once a slot requires a new EV, the in-order delivery will be broken from that slot. In an embodiment, a scheme that supports generations can be implemented, where the first log k bits encode the slot, and the remaining bits encode the generation number. When changing an EV in a slot, the generation number can be increased to obtain a new EV and send a last probe packet to clear the old EV. The last PSN sent on the old EV for this slot can be stored and the tracker entry removed once it has been received or once the final probe packet has been received on this old EV. In any case, the old EV is remembered for this slot until all packets have arrived. Potentially, multiple old EVs need to be remember or stored per slot if a fully accurate scheme is desired. The memorization of old EVs can be skipped at the cost of false negatives. In the worst case, the EV can be changed at every iteration, and stored for one BDP, which requires ˜8,000*13b of storage for the parameters above.

In an embodiment, a further optimization for a receiver-based loss detection scheme can be implemented with a minimal memory overhead that is independent of the number of slots (e.g., REPS). Assume that there is a fixed number of k entropy slots that both sender and receiver have determined upfront. Assume that the system starts at a PSN that is divisible by k, i.e., start PSN mod k=0. The entropy slot s for each PSN can be derived using s=PSN mod k, so it is carried in each packet. The special case for k being a power of two is efficient as the least significant log k bits of the PSN can be used to find the slot at the receiver.

All EV bits are used to encode the base PSN (bPSN) which are the least significant 16 bits of the PSN of the first packet to be sent with this new EV. If a new EV is needed for a slot (e.g., when the old one experiences congestion or is timed out), the bits from the current send PSN can be used. This assumes that the ECMP hash function mixes well (distributes keys uniformly over the output space).

In one embodiment, it is assumed that the receiver maintains a bitmap to determine successfully received packets. The receiver now finds the PSN for the smallest zero bit whose offset is greater than or equal to bPSN and which is divisible by s, which is referred to as zPSN. If the packet's PSN==zPSN, then zPSN is marked as received and the process continues. If not, then the number of lost packets are determined by the number of zero bits that are divisible by s and are between bPSN and zPSN. These are NACK′ed. This scheme requires the sender to store the base PSN to send for each slot, but it is not required to store multiple generations as in the previous scheme.

This scheme requires that each sequence of packets that carries the same bPSN as the EV is consecutive (modulo k). This can be ensured by making the bPSN monotonically increasing (whenever a slot changes PSN, select a bPSN that is larger than any PSN that can arrive at the destination later than the packet carrying the new bPSN). This can be achieved by selecting the current send PSN (for the slot) as bPSN at the sender whenever EVs are switched.

This scheme can be extended to a REPS-like stateless form where EVs are “stored” on the wire. This requires some additional initialization because REPS does not aim to re-use the same EV, which is necessary for the disclosed loss detection scheme. The modified REPS starts by sending m (configurable) packets with the same EV. An example starting point is to select k virtual slots and round-robin over the selected virtual slots with EVs as the slot-id (0 . . . k−1) and round-robin over the selected virtual slots until m*k packets have been sent. Now, each slot carries m packets with the same EV-m is selected to be large enough such that REPS can return the first EVs into the sender cache before m is exhausted at the sender. This will start with an equilibrium (e.g., configure m depending on the BDP). If an EV needs to be changed, all EVs must be changed on that virtual slot. This can be done with a temporary transition state as follows: assume there are four slots and it is desired to change the EV for slot 0 from 0 on PSN 16. The new EV will thus be 16 for PSN 16. The cache stores that all arriving EVs are to be translated 0 to 16 until PSN 16−4=14 is received. The temporary translation can be stopped because the last packet from EV zero is drained. This state needs to time out as ACKs carrying EV 0 may be lost. If packets (data or ACK) are lost with EVs in flight, the packet with the latest EV of that virtual slot needs to be retransmitted.

Referring to FIG. 1A, illustrated is an example with a base scheme (fixed or static EVs). FIG. 1A illustrates a sender 101 and receiver 102 and packets 103 flowing from sender 101 to receiver 102 and ACKs flowing back. Entropy vectors (EVs) 104 select a path. If two packets have the same EV, they arrive at the receiver in the order they were sent. FIG. 1A shows 4 slots 107 and each packet in a message has a packet sequence number (PSN) 106, e.g., 0, 1, 2, 3, 4, 5, 6, 7, 8, 9, 10, 11, 12.

Each of the slots has 107 have a statically assigned EV 104. For example, 0, 1, 2, 3 are concatenated with A, B, C, and D. In an example, round robin is applied across the slots, thus zero in slot zero with EVOA, 1 in slot one with EV1B, and so on. If a packet sequence number is divisible by 4, it has been sent across slot 0. If the modulo dividing by 4 is one, then it has been sent across 1, and more generally, if the modulo dividing by S which is the slot number is S, then it has been in the slot S. In an embodiment, the slot ID is encoded as part of the EV. The destination has an expected packet sequence number.

Referring to FIG. 1B, in an example PSN 4 has been dropped 110. The loss of PSN 4 was dropped and the receiver received PSN 8. The expected PSN is the last received PSN plus the number of slots plus four in this example. For PSN 1, 5, 9, there is no loss. For PSN 3, 7 and 11, 3 and 7 are dropped, and 11 is received but the expected is 3. Using mod 4, it is determined that 3 and 7 should have been received 111.

Referring to FIG. 1C, instead of encoding a random value into this EV 120, a generation number 121 is encoded. In this example, the EVs are now 00, 10, 20, 30 using concatenation.

Referring to FIG. 1D, a change to the EV is desired, and thus PSN 4 takes a different path. PSN 4 is dropped 130 in this example. Because PSN 4 took a different path, PSN 4 could have arrived before PSN 0. Thus, the source remembers for outstanding packets that there is a generation 0 and generation 1.

Referring to FIG. 1E, the packet sequence number 150 is a 32 bit number and the EV 151 is 16 bit, encoded as the least significant 16 bits of the packet sequence number. FIG. 1E illustrates virtual slots 152 at the destination.

Referring to FIG. 1F, illustrated is a bitmap 160 that includes the offset PSN 161, with a 0 or 1 indicating whether a respective PSN was received. In this example, each of the bits corresponds to a slot, with every 4th bit from the offset corresponding to the next PSN for the slot.

Referring to FIG. 1G, illustrated is an example with an update in the EV 170, using the lowest 16 bits of the PSN. The base PSN determines the starting point in the bitmap, which is updated when a path is changed.

Referring to FIG. 1H, illustrated is an example with virtual slots 180 and EVs in the packets on the wire.

FIG. 1I illustrates various aspects of the disclosed embodiments. In a computing network 115 implementing packet delivery contexts (PDCs), an entropy value 116 is generated for a data packet 117 to be transmitted on the computing network 115. The entropy value 116 is usable to select or change a network path 118 for the data packet 117. The network path 118 may traverse a number of network devices or nodes which may include node A 121, node B 123, node C 122, and node D 124, and switch 1 125 and switch 2 126. In response to receiving an acknowledgement message for the data packet, the entropy value 116 is saved in a storage structure 119 if the entropy value 116 is acknowledged as not congested. When transmitting an additional data packet, an oldest saved entropy 120 is reused from the data structure 119 and the oldest saved entropy value 120 is invalidated.

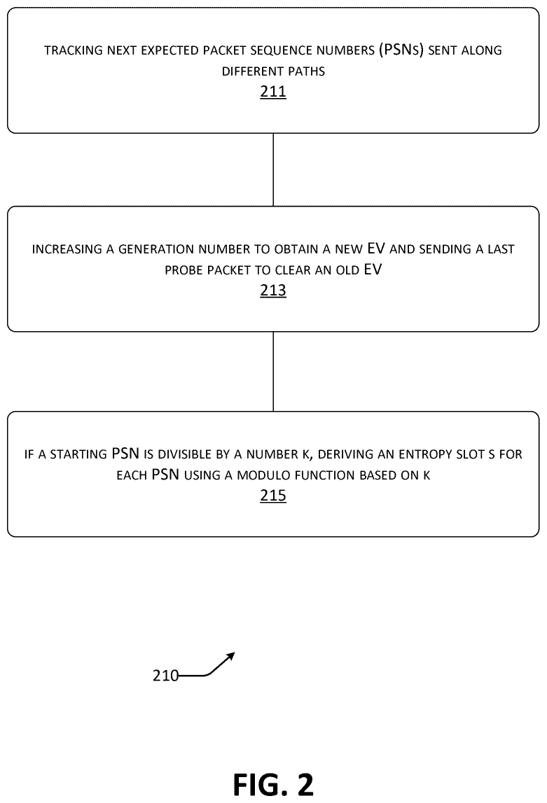

Turning now to FIG. 2, illustrated is an example operational procedure 210 for managing a computing network implementing an adaptive load balancing scheme using entropy values (EVs) to select network paths.

Such an operational procedure can be provided by one or more components illustrated in FIGS. 1-7. The operational procedure may be implemented in a system comprising one or more network devices or computing devices. It should be understood by those of ordinary skill in the art that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, performed together, and/or performed simultaneously, without departing from the scope of the appended claims.

It should also be understood that the illustrated methods can end at any time and need not be performed in their entireties. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

It should be appreciated that the logical operations described herein are implemented (1) as a sequence of computer implemented acts or program modules running on a computing system such as those described herein) and/or (2) as interconnected machine logic circuits or circuit modules within the computing system. The implementation is a matter of choice dependent on the performance and other requirements of the computing system. Accordingly, the logical operations may be implemented in software, in firmware, in special purpose digital logic, and any combination thereof. Thus, although the routine 210 is described as running on a system, it can be appreciated that the routine 210 and other operations described herein can be executed on an individual computing device or several devices.

Referring to FIG. 2, operation 211 illustrates tracking next expected packet sequence numbers (PSNs) sent along different paths.

Operation 213 illustrates increasing a generation number to obtain a new EV and sending a last probe packet to clear an old EV.

Operation 215 illustrates if a starting PSN is divisible by a number k, deriving an entropy slot s for each PSN using a modulo function based on k.

For ease of understanding, the processes discussed in this disclosure are delineated as separate operations represented as independent blocks. However, these separately delineated operations should not be construed as necessarily order dependent in their performance. The order in which the process is described is not intended to be construed as a limitation, and any number of the described process blocks may be combined in any order to implement the process or an alternate process. Moreover, it is also possible that one or more of the provided operations is modified or omitted. Furthermore, one or more of the provided operations may also be executed in parallel and/or interleaved when processing multiple network packets.

The particular implementation of the technologies disclosed herein is a matter of choice dependent on the performance and other requirements of a computing device. Accordingly, the logical operations described herein are referred to variously as states, operations, structural devices, acts, or modules. These states, operations, structural devices, acts, and modules can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated methods can end at any time and need not be performed in their entireties. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the routine 210 can be implemented, at least in part, by modules running the features disclosed herein can be a dynamically linked library (DLL), a statically linked library, functionality produced by an application programing interface (API), a compiled program, an interpreted program, a script, or any other executable set of instructions. Data can be stored in a data structure in one or more memory components. Data can be retrieved from the data structure by addressing links or references to the data structure.

Although the illustration may refer to the components of the figures, it should be appreciated that the operations of the routine 210 may be also implemented in other ways. In addition, one or more of the operations of the routine 210 may alternatively or additionally be implemented, at least in part, by a chipset working alone or in conjunction with other software modules. In the example described below, one or more modules of a computing system can receive and/or process the data disclosed herein. Any service, circuit, or application suitable for providing the techniques disclosed herein can be used in operations described herein.

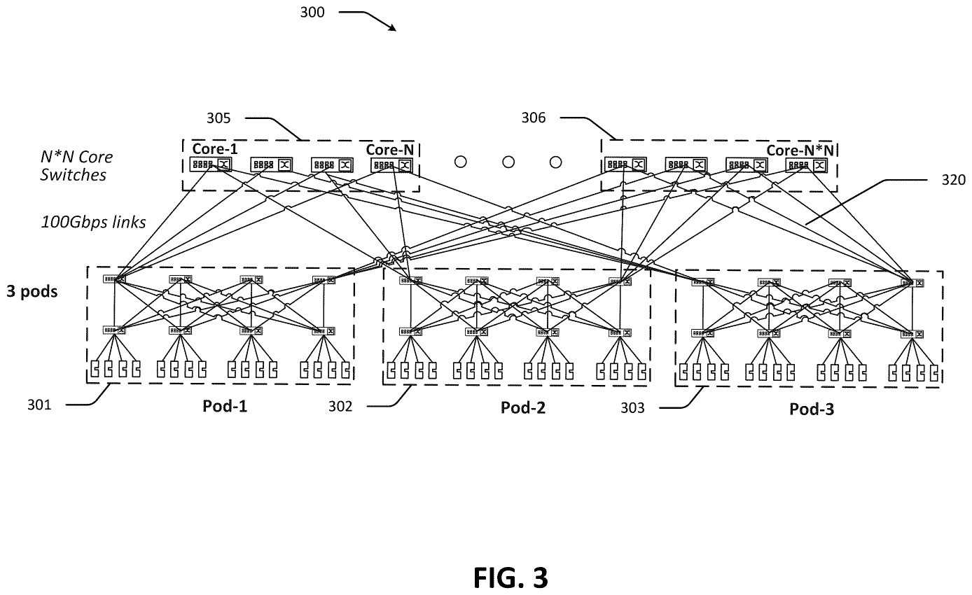

FIG. 3 illustrates an example communications network environment 300 containing N*N core switches such as Core-1 305 through Core N*N 306. The N*N core switches are communicatively coupled, in this example, to three pods 301, 302, 303 via 100 Gbps links 320. In an example, each pod can include set of computing nodes and network devices that are configured to run containers or virtual machines.

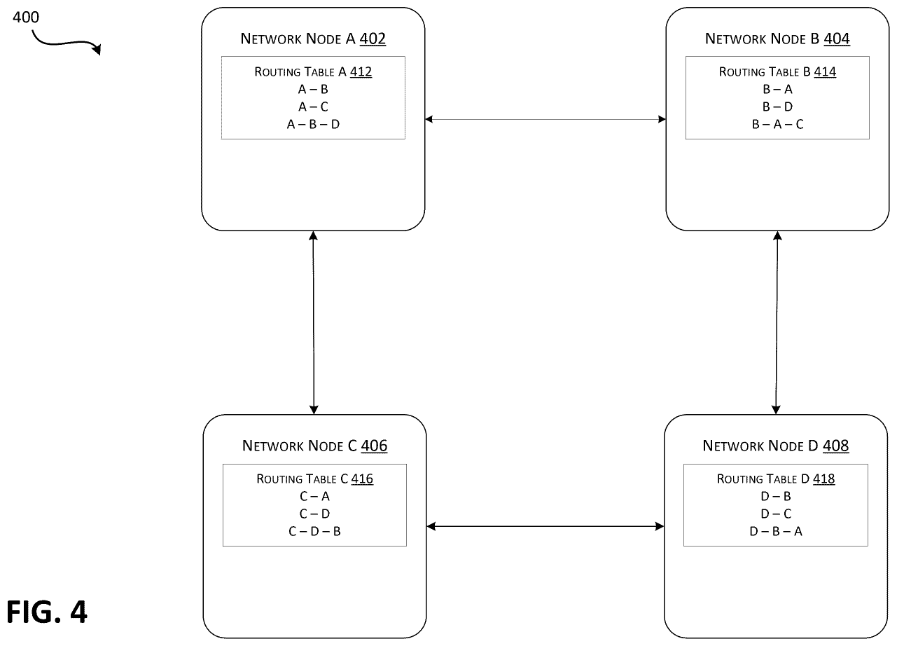

FIG. 4 illustrates an example communications network environment 400 containing a first communication node A 402, a second communication node B 404, a third communication node C 406, and a fourth communication node D 408. In addition, each node is configured with an associated routing table A-D 412-418. Each routing table contains data defining paths with which a node can route data from itself to other nodes within the network. It should be understood that the routing tables can be populated through any method such as static routing or dynamic routing. Furthermore, the routing tables can be modified automatically by the nodes themselves or manually such as by a system engineer.

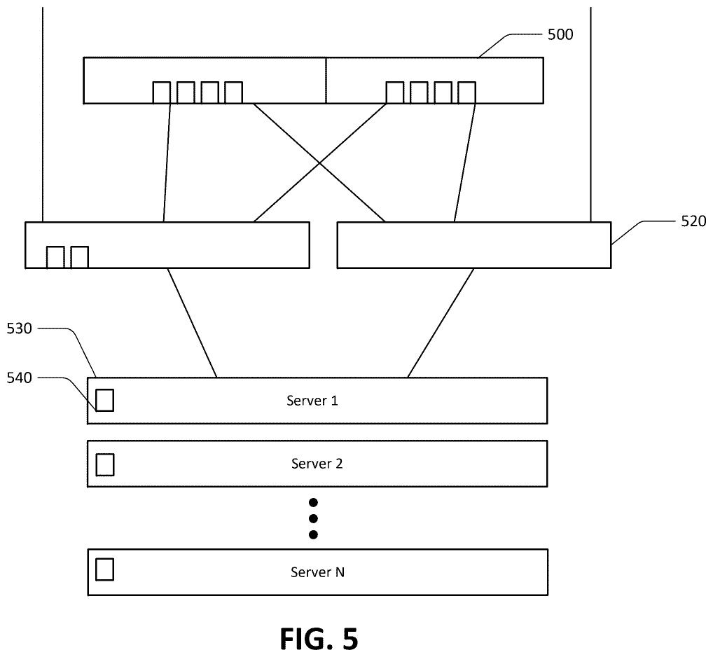

With reference to FIG. 5, illustrated is an example network topology. In one implementation, various network devices may be configured to provide data to servers (hosts) 530. In an embodiment, each network device 520 may be fully connected to each server 530. FIG. 5 also shows that network device 520 may be coupled to additional network devices 500. The servers 530 may include NICs 540 for providing network connectivity. The various embodiments disclosed herein can be implemented in NICs 540, network device 520, servers 530, or other devices in a computing network.

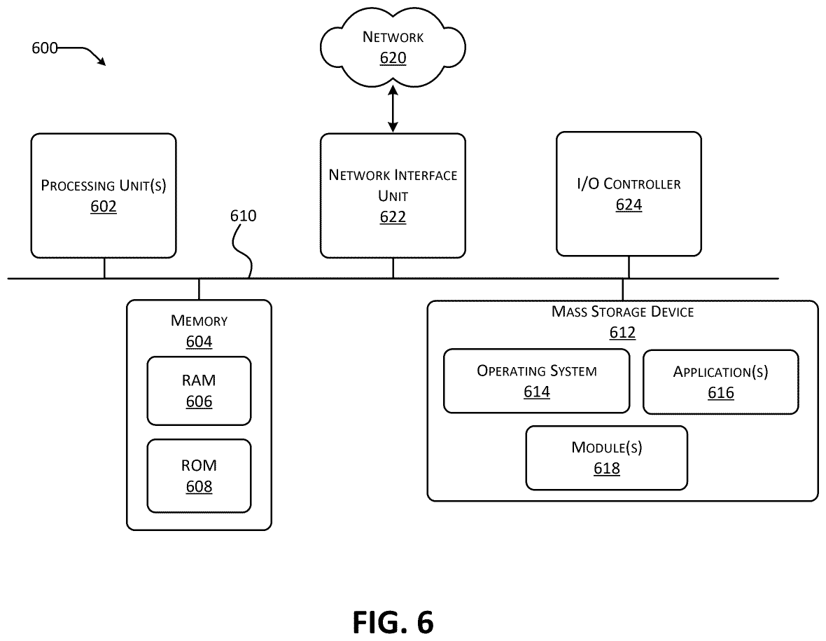

FIG. 6 shows additional details of an example computer architecture 600 for a device, such as a computer or a server configured as part of a cloud-based platform or system, capable of executing computer instructions (e.g., a module or a program component described herein). The computer architecture 600 illustrated in FIG. 6 includes processing system 602, a system memory 604, including a random-access memory 606 (RAM) and a read-only memory (ROM) 608, and a system bus 610 that couples the memory 604 to the processing system 602. The processing system 602 comprises processing unit(s). In various examples, the processing unit(s) of the processing system 602 are distributed. Stated another way, one processing unit of the processing system 602 may be located in a first location (e.g., a rack within a datacenter) while another processing unit of the processing system 602 is located in a second location separate from the first location.

Processing unit(s), such as processing unit(s) of processing system 602, can represent, for example, a CPU-type processing unit, a GPU-type processing unit, a field-programmable gate array (FPGA), another class of digital signal processor (DSP), or other hardware logic components that may, in some instances, be driven by a CPU. For example, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), and the like.

A basic input/output system containing the basic routines that help to transfer information between elements within the computer architecture 600, such as during startup, is stored in the ROM 608. The computer architecture 600 further includes a mass storage device 612 for storing an operating system 614, application(s) 616, modules 618, and other data described herein.

The mass storage device 612 is connected to processing system 602 through a mass storage controller connected to the bus 610. The mass storage device 612 and its associated computer-readable media provide non-volatile storage for the computer architecture 600. Although the description of computer-readable media contained herein refers to a mass storage device, the computer-readable media can be any available computer-readable storage media or communication media that can be accessed by the computer architecture 600.

Computer-readable media includes computer-readable storage media and/or communication media. Computer-readable storage media includes one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including RAM, static RAM (SRAM), dynamic RAM (DRAM), phase change memory (PCM), ROM, erasable programmable ROM (EPROM), electrically EPROM (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer-readable storage media, communication media can embody computer-readable instructions, data structures, program modules, or other data in a modulated data signal, such as a carrier wave, or other transmission mechanism. As defined herein, computer storage media does not include communication media. That is, computer-readable storage media does not include communications media consisting solely of a modulated data signal, a carrier wave, or a propagated signal, per se.

According to various configurations, the computer architecture 600 may operate in a networked environment using logical connections to remote computers through the network 620. The computer architecture 600 may connect to the network 620 through a network interface unit 622 connected to the bus 610. The computer architecture 600 also may include an input/output controller 624 for receiving and processing input from a number of other devices, including a keyboard, mouse, touch, or electronic stylus or pen. Similarly, the input/output controller 624 may provide output to a display screen, a printer, or other type of output device.

The software components described herein may, when loaded into the processing system 602 and executed, transform the processing system 602 and the overall computer architecture 600 from a general-purpose computing system into a special-purpose computing system customized to facilitate the functionality presented herein. The processing system 602 may be constructed from any number of transistors or other discrete circuit elements, which may individually or collectively assume any number of states. More specifically, the processing system 602 may operate as a finite-state machine, in response to executable instructions contained within the software modules disclosed herein. These computer-executable instructions may transform the processing system 602 by specifying how the processing system 602 transition between states, thereby transforming the transistors or other discrete hardware elements constituting the processing system 602.

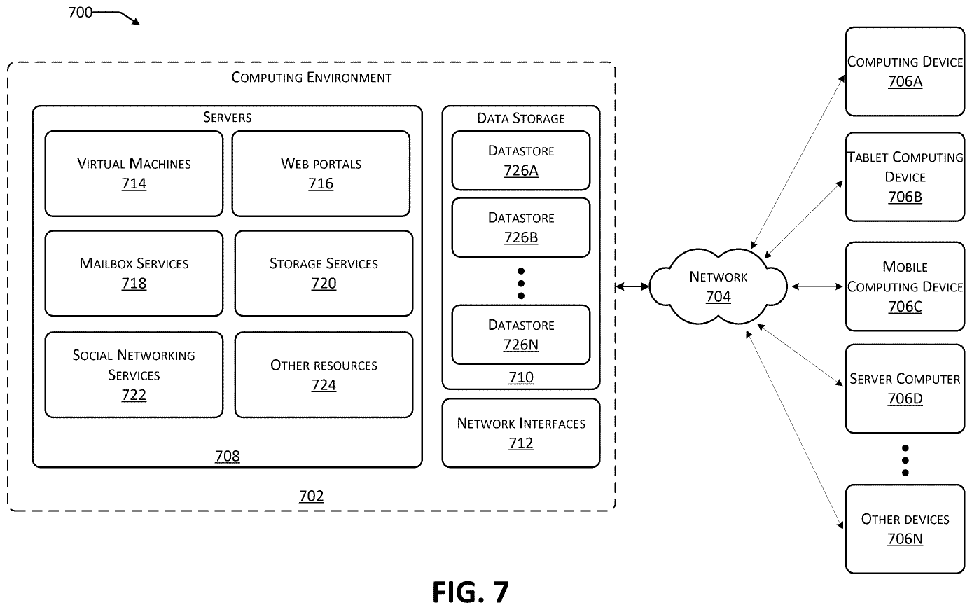

FIG. 7 depicts an illustrative distributed computing environment 700 capable of executing the software components described herein. Thus, the distributed computing environment 700 illustrated in FIG. 7 can be utilized to execute any aspects of the software components presented herein. For example, the distributed computing environment 700 can be utilized to execute aspects of the software components described herein. Accordingly, the distributed computing environment 700 can include a computing environment 702 operating on, in communication with, or as part of the network 704. The network 704 can include various access networks. One or more client devices 706A-706N (hereinafter referred to collectively and/or generically as “computing devices 706”) can communicate with the computing environment 702 via the network 704. In one illustrated configuration, the computing devices 706 include a computing device 706A such as a laptop computer, a desktop computer, or other computing device; a slate or tablet computing device (“tablet computing device”) 706B; a mobile computing device 706C such as a mobile telephone, a smart phone, or other mobile computing device; a server computer 706D; and/or other devices 706N. It should be understood that any number of computing devices 706 can communicate with the computing environment 702.

In various examples, the computing environment 702 includes servers 708, data storage 710, and one or more network interfaces 712. The servers 708 can host various services, virtual machines, portals, and/or other resources. In the illustrated configuration, the servers 708 host virtual machines 714, Web portals 716, mailbox services 718, storage services 720, and/or social networking services 722. As shown in FIG. 7 the servers 708 also can host other services, applications, portals, and/or other resources (“other resources”) 724.

As mentioned above, the computing environment 702 can include the data storage 710. According to various implementations, the functionality of the data storage 710 is provided by one or more databases operating on, or in communication with, the network 704. The functionality of the data storage 710 also can be provided by one or more servers configured to host data for the computing environment 700. The data storage 710 can include, host, or provide one or more real or virtual datastores 726A-726N (hereinafter referred to collectively and/or generically as “datastores 726”). The datastores 726 are configured to host data used or created by the servers 708 and/or other data. That is, the datastores 726 also can host or store web page documents, word documents, presentation documents, data structures, algorithms for execution by a recommendation engine, and/or other data utilized by any application program. Aspects of the datastores 726 may be associated with a service for storing files.

The computing environment 702 can communicate with, or be accessed by, the network interfaces 712. The network interfaces 712 can include various types of network hardware and software for supporting communications between two or more computing devices including the computing devices and the servers. It should be appreciated that the network interfaces 712 also may be utilized to connect to other types of networks and/or computer systems.

It should be understood that the distributed computing environment 700 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 700 provides the software functionality described herein as a service to the computing devices. It should be understood that the computing devices can include real or virtual machines including server computers, web servers, personal computers, mobile computing devices, smart phones, and/or other devices. As such, various configurations of the concepts and technologies disclosed herein enable any device configured to access the distributed computing environment 700 to utilize the functionality described herein for providing the techniques disclosed herein, among other aspects.

The disclosure presented herein encompasses the subject matter set forth in the following example clauses.

Clause 1: A method for managing a computing network implementing an adaptive load balancing scheme using entropy values (EVs) to select network paths, the method com:
tracking next expected packet sequence numbers (PSNs) sent along different paths;
increasing a generation number to obtain a new EV and sending a last probe packet to clear an old EV; and
if a starting PSN is divisible by a number k, deriving an entropy slot s for each PSN using a modulo function based on k.

Clause 2: The method of clause 1, wherein the tracking comprises:
after sending a packet, locally storing the packet's PSN an expected PSN for a specific EV.

Clause 3: The method of any of clauses 1-2, wherein if an ACK with a corresponding EV arrives that has a different PSN as the expected PSN, determining that at least one packet was lost.

Clause 4: The method of any of clauses 1-3, wherein if a number of different entropy slots is a constant m and packets are sent using round robin, expected packets are computed as ePSN+(i*m) for the i^{th} packet.

Clause 5: The method of any of clauses 1-4, further comprising:
encoding a slot as the first log k bits;
encoding a generation number using remaining bits;
when changing an EV in a slot, increasing the generation number to obtain a new EV; and
sending a final probe packet to clear the previous EV.

Clause 6: The method of any of clauses 1-5, further comprising:
storing the last PSN sent on the old EV for this slot; and
removing a tracker entry when the last PSN has been received or when the final probe packet has been received on the old EV.

Clause 7: The method of any of clauses 1-6, wherein the entropy slot for each PSN is derived using PSN mod k wherein k is a fixed number of entropy slots predetermined by sender and receiver nodes.

Clause 8: A system for managing a computing network implementing an adaptive load balancing scheme using entropy values (EVs) to select network paths, the system comprising a network device and computing node, the system configured to perform operations comprising:
tracking next expected packet sequence numbers (PSNs) sent along different paths indicated by different EVs;
increasing a generation number to obtain a new EV and sending a last probe packet to clear an old EV; and
if a starting PSN is divisible by k, deriving an entropy slot s for each PSN using s=PSN mod k.

Clause 9: The system of clause 8, wherein the tracking comprises:
after sending a packet, locally storing the packet's PSN an expected PSN for a specific EV.

Clause 10: The system of any of clauses 8 and 9, wherein if an ACK with a corresponding EV arrives that has a different PSN as the expected PSN, determining that at least one packet was lost.

Clause 11: The system of any clauses 8-10, wherein if a number of different entropy slots is a constant n and packets are sent using round robin, expected packets are computed as ePSN+(i*n) for the i^{th} packet.

Clause 12: The system of any clauses 8-11, the system further configured to perform operations comprising:
encoding a slot as the first log k bits;
encoding a generation number using remaining bits;
when changing an EV in a slot, increasing the generation number to obtain a new EV; and
sending a final probe packet to clear the previous EV.

Clause 13: The system of any clauses 8-12, the system further configured to perform operations comprising:
storing the last PSN sent on the old EV for this slot; and
removing a tracker entry when the last PSN has been received or when the final probe packet has been received on the old EV.

Clause 14: The system of any clauses 8-13, wherein the entropy slot for each PSN is derived using PSN mod k wherein k is a fixed number of entropy slots predetermined by sender and receiver nodes.

Clause 15: A computer readable storage medium comprising computer readable instructions for managing a computing network implementing an adaptive load balancing scheme using entropy values (EVs) to select network paths, the computer readable instructions operable, when executed by a computing node, to perform operations comprising:
tracking next expected packet sequence numbers (PSNs) sent along different EVs/paths;
increasing a generation number to obtain a new EV and sending a last probe packet to clear an old EV; and
if a starting PSN is divisible by k, deriving an entropy slot s for each PSN using s=PSN mod k.

Clause 16: The computer readable storage medium of clause 15, wherein the tracking comprises:
after sending a packet, locally storing the packet's PSN an expected PSN for a specific EV.

Clause 17: The computer readable storage medium of any of clauses 15 and 16, wherein if an ACK with a corresponding EV arrives that has a different PSN as the expected PSN, determining that at least one packet was lost.

Clause 18: The computer readable storage medium of any clauses 15-17, wherein if a number of different entropy slots is a constant u and packets are sent using round robin, expected packets are computed as ePSN+(i*u) for the i^{th} packet . . .

Clause 19: The computer readable storage medium of any clauses 15-18, further comprising computer readable instructions operable, when executed by a computing node, to perform operations comprising:
encoding a slot as the first log k bits;
encoding a generation number using remaining bits;
when changing an EV in a slot, increasing the generation number to obtain a new EV; and
sending a final probe packet to clear the previous EV

Clause 20: The computer readable storage medium of any clauses 15-19, further comprising computer readable instructions operable, when executed by a computing node, to perform operations comprising:
storing the last PSN sent on the old EV for this slot; and
removing a tracker entry when the last PSN has been received or when the final probe packet has been received on the old EV.

1. A method for managing a computing network implementing an adaptive load balancing scheme using entropy values (EVs) to select network paths, the method comprising:
tracking next expected packet sequence numbers (PSNs) sent along different paths;
increasing a generation number to obtain a new EV and sending a last probe packet to clear an old EV; and
if a starting PSN is divisible by a number k, deriving an entropy slot s for each PSN using a modulo function based on k.

2. The method of claim 1, wherein the tracking comprises:
after sending a packet, locally storing the packet's PSN an expected PSN for a specific EV.

3. The method of claim 2, wherein if an ACK with a corresponding EV arrives that has a different PSN as the expected PSN, determining that at least one packet was lost.

4. The method of claim 1, wherein if a number of different entropy slots is a constant m and packets are sent using round robin, expected packets are computed as ePSN+(i*m) for the i^{th} packet.

5. The method of claim 1, further comprising:
encoding a slot as the first log k bits;
encoding a generation number using remaining bits;
when changing an EV in a slot, increasing the generation number to obtain a new EV; and
sending a final probe packet to clear a previous EV.

6. The method of claim 5, further comprising:
storing the last PSN sent on the old EV for this slot; and
removing a tracker entry when the last PSN has been received or when the final probe packet has been received on the old EV.

7. The method of claim 1, wherein the entropy slot for each PSN is derived using PSN mod k wherein k is a fixed number of entropy slots predetermined by sender and receiver nodes.

8. A system for managing a computing network implementing an adaptive load balancing scheme using entropy values (EVs) to select network paths, the system comprising a network device and computing node, the system configured to perform operations comprising:
tracking next expected packet sequence numbers (PSNs) sent along different paths indicated by different EVs;
increasing a generation number to obtain a new EV and sending a last probe packet to clear an old EV; and
if a starting PSN is divisible by k, deriving an entropy slot s for each PSN using s=PSN mod k.

9. The system of claim 8, wherein the tracking comprises:
after sending a packet, locally storing the packet's PSN an expected PSN for a specific EV.

10. The system of claim 9, wherein if an ACK with a corresponding EV arrives that has a different PSN as the expected PSN, determining that at least one packet was lost.

11. The system of claim 8, wherein if a number of different entropy slots is a constant n and packets are sent using round robin, expected packets are computed as ePSN+(i*n) for the i^{th} packet.

12. The system of claim 8, the system further configured to perform operations comprising:
encoding a slot as the first log k bits;
encoding a generation number using remaining bits;
when changing an EV in a slot, increasing the generation number to obtain a new EV; and
sending a final probe packet to clear a previous EV.

13. The system of claim 12, further comprising:
storing the last PSN sent on the old EV for this slot; and
removing a tracker entry when the last PSN has been received or when the final probe packet has been received on the old EV.

14. The system of claim 13, wherein the entropy slot for each PSN is derived using PSN mod k wherein k is a fixed number of entropy slots predetermined by sender and receiver nodes.

15. A computer readable storage medium comprising computer readable instructions for managing a computing network implementing an adaptive load balancing scheme using entropy values (EVs) to select network paths, the computer readable instructions operable, when executed by a computing node, to perform operations comprising:
tracking next expected packet sequence numbers (PSNs) sent along different EVs/paths;
increasing a generation number to obtain a new EV and sending a last probe packet to clear an old EV; and
if a starting PSN is divisible by k, deriving an entropy slot s for each PSN using s=PSN mod k.

16. The computer readable storage medium of claim 15, wherein the tracking comprises:
after sending a packet, locally storing the packet's PSN an expected PSN for a specific EV.

17. The computer readable storage medium of claim 16, wherein if an ACK with a corresponding EV arrives that has a different PSN as the expected PSN, determining that at least one packet was lost.

18. The computer readable storage medium of claim 15, wherein if a number of different entropy slots is a constant u and packets are sent using round robin, expected packets are computed as ePSN+(i*u) for the i^{th} packet.

19. The computer readable storage medium of claim 15, further comprising:
encoding a slot as the first log k bits;
encoding a generation number using remaining bits;
when changing an EV in a slot, increasing the generation number to obtain a new EV; and
sending a final probe packet to clear a previous EV.

20. The computer readable storage medium of claim 19, further comprising:
storing the last PSN sent on the old EV for this slot; and
removing a tracker entry when the last PSN has been received or when the final probe packet has been received on the old EV.
